(19) United States
(12) Patent Application Publication
(10) Pub. No.: US 2006/0186026 A1
(43) Pub. Date: Aug. 24, 2006

(54) Compact water purification apparatus

(76) Inventor: Mohamad K. Saleh, Perrysburg, OH (US)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/346,945

(22) Filed: Feb. 3, 2006

Related U.S. Application Data
(63) Continuation of application No. PCT/US04/24838, filed on Aug. 3, 2004.
(60) Provisional application No. 60/492,460, filed on Aug. 4, 2003.
(60) Provisional application No. 60/568,305, filed on May 5, 2004.

(51) Int. Cl. B01D 35/00

(52) U.S. Cl. 210/134; 210/323.1; 210/295; 210/259; 210/435; 210/138; 210/266; 210/192

(57) ABSTRACT

A compact water purification apparatus (70) for purifying water from a municipal water supply prior to a point of use has multiple water purification units (72, 74, 76, 78) that can include cartridge filters for removing such as chlorine, rust and sediment, chlorine and heavy metal, dissolved iron and hydrogen sulfide, chlorine and chloroform, lead, and sediment. Also connected in series is an ultraviolet light source (80). A bypass conduit (18) connected in parallel with the water purification units and valves (30, 32, 34) permits the water from the supply to flow directly to the point of use.

### CROSS-REFERENCE TO RELATED APPLICATION

This application claims the benefit of U.S. Provisional patent applications ser. No. 60/492,460 filed Aug. 4, 2003 and serial no. 60/568,305 filed May 5, 2004.

### BACKGROUND OF THE INVENTION

The present invention relates generally to water purification systems and, in particular, to a point of use water purification apparatus utilizing a multi-step purification process in a compact package.

Water purification systems and methods are well known. Ensuring a safe and healthy water supply free from particle, chemical and microbiological impurities, such as bacteria and the like, is an ongoing concern in many parts of the world. The prior art has recognized this and provided various biocides and other systems aimed at exterminating and/or removing bacteria. Perhaps the most common means for exterminating and/or removing bacteria from water supplies is with the use of chlorine.

Chlorine is a powerful oxidizing agent and biocide and has been used for many years by municipal water treatment systems to disinfect water for personal and commercial use. Although it is an effective biocide and is economical to use, chlorine has been suspected to adversely affect living organisms when supplied at excessive levels beyond that required to exterminate the bacteria. In addition to initially treating the water,. the water treatment system also typically supplies a residual, called the free chlorine residual, to maintain a level of chlorine sufficient to protect the water from bacteria throughout the water distribution system and the network leading to its point of use. In order to ensure an effective level of chlorine at the point of use farthest from the source, the chlorine level at points of use closer to the source will be higher than desirable. The impact of the free residual chlorine is disadvantageous and significant. The free chlorine residual alters the odor and taste of water as well as bleaches any colored organic objects including skin and hair. In addition, chlorine is itself suspected to be a carcinogen as well as a key component in the formation of trihalomethanes, which are also carcinogenic.

Despite the disadvantages and risks noted above, chlorine remains arguably the most economical and effective biocide for drinking water ever used and, therefore, its use as a biocide remains prevalent today. Many prior art systems exist that teach means to remove chlorine from water. Other prior art systems exist that teach other biocides as substitutes for chlorine. Most of these prior art removal systems or chlorine substitutes are either cost-prohibitive, difficult to apply, difficult to maintain, or a combination of all of the above.

It is desirable to provide an apparatus for removing chlorine from a municipal water supply that is both economical and simple to apply.

It is also desirable to provide an apparatus for removing chlorine that is simple to operate and maintain. It is also desirable to provide an apparatus that may be maintained while still sustaining water flow for the point of use.

It is, therefore, an object of the present invention to provide an apparatus to eliminate taste, odor, and health-related effects associated with the free chlorine residual provided from a municipal water supply. It is another object of the invention to provide an apparatus for removing chlorine from a municipal water supply at a point of use which apparatus is economical and simple to apply, operate, and maintain.

### SUMMARY OF THE INVENTION

The present invention concerns a compact water purification apparatus for connection to a water supply having substances to be removed. This apparatus is compact and easily installed in a house or a commercial building. The apparatus according to the present invention advantageously permits the selection of different types of filter cartridges to match filtration requirements.

The present invention advantageously contemplates utilizing low-cost, commercially available standard equipment to eliminate substances such as chlorine from drinking water and from water used in food, beverage, and related uses. Furthermore, the present invention advantageously provides a bypass conduit to allow easy maintenance of the components of the present invention. The present invention also extends the life or operating hours of the water filters and the ultraviolet light source by utilizing the bypass conduit during periods when the purification process is not needed. For example, during closing hours of a business establishment, office, etc. The bypassed chlorinated water can flow until it is necessary to go back to the purified water during demand or peak use periods. This operation also keeps the bypass conduit bacteria free with the chlorinated water flow. The present invention, therefore, is a low-cost yet effective and efficient means for removing chlorine from a municipal water supply. In addition to domestic potable water use, the present invention contemplates uses in many industrial sectors where chlorine can affect the process or final product characteristics including, but not limited to, the paper, textiles, food, and beverage industries.

In addition, the present invention is scalable in that it is not limited to certain values of water flow, the amount of free residual chlorine, or the amount of TDS. Filter and piping sizes are dependent on a number of factors, including water flow and the amount of free chlorine measured in the water. The components of the present invention (the water filters and the ultraviolet light source) can be custom designed for each specific point of use water distribution system, and it also is within the scope of the present invention to mass produce the components for typical residential applications.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic block diagram of a water purification apparatus in accordance with the present invention;

FIG. 2 is a schematic block diagram of an alternate embodiment of the apparatus shown in FIG. 1;

FIG. 3 is a schematic block diagram of a control for the apparatus shown in FIG. 1;

FIG. 4 is a schematic perspective view of a compact water purification apparatus in accordance with the present invention; and

FIG. 5 is a schematic block diagram of a remote control circuit for operating the valves of the water purification system according to the present invention.

### DESCRIPTION OF THE PREFERRED EMBODIMENT

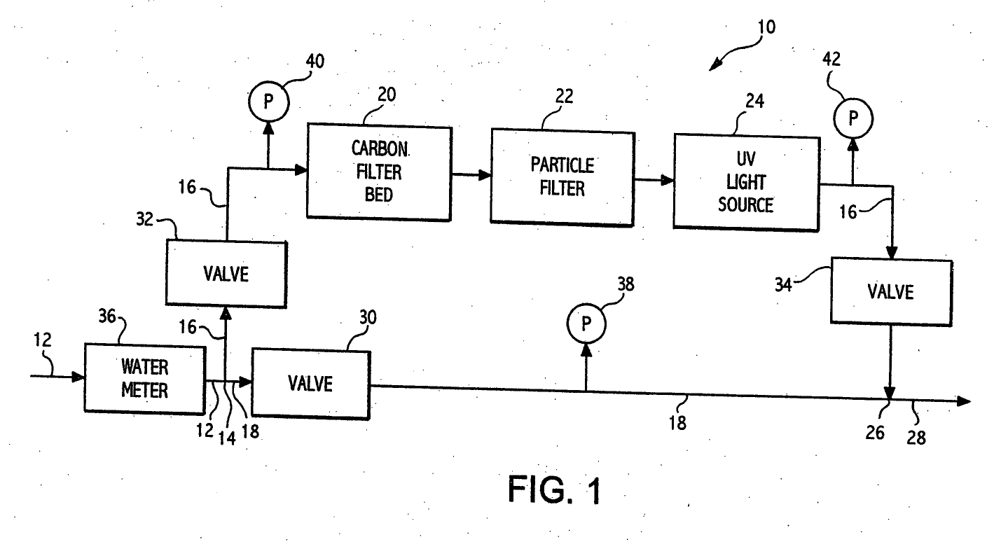

Incorporated herein by reference is U.S. Pat. No. 6,723,232, issued Apr. 20, 2004, from which FIGS. 1-3 are taken. Referring now to FIG. 1, a water purification apparatus is indicated generally at 10. The water purification apparatus 10 includes a water supply inlet conduit 12. The water supply inlet conduit 12 is preferably piping, tubing, or the like that is connected to a chlorinated municipal water supply network (not shown) for receiving water to be used at a point of use for drinking, cooking, bathing, etc. The water supply inlet conduit 12 may be constructed of any suitable conduit material including, but not limited to, steel, copper, or polyvinyl chloride (PVC). The water supply inlet conduit 12 extends to a tee coupling 14, which branches to a filtration apparatus inlet conduit 16 and a bypass conduit 18. The apparatus inlet conduit 16, the bypass conduit 18, and the tee 14 may be constructed of any suitable conduit material including, but not limited to, steel, copper, or PVC.

The apparatus inlet conduit 16 connects to an inlet of a carbon filter bed 20. The carbon filter 20 includes carbon beds (not shown) that have a quantity of activated charcoal (not shown) for absorbing free residual chlorine (not shown) contained in the water flowing from the municipal water supply. The carbon filter 20 is preferably a commercially available carbon filter bed. The carbon filter 20 is preferably sized to remove all or substantially all of the chlorine based upon a maximum flow capacity of the point of use and the amount of chlorine in the water at the supply inlet conduit 12. Alternatively, the carbon filter 20 is formed of two or more such filters connected in parallel and/or series depending on the amount of free chlorine residual to be removed. Typically, two or more filters would be required only in large commercial or industrial applications.

An outlet of the carbon filter 20 is connected to an inlet of a particle filter 22. The particle filter 22 is preferably a particulate filter that can remove carbon particles (not shown) shed from the carbon filter 20 as well as any other solid particles (not shown) found in the water received from the municipal water supply. The particle filter 22 is preferably a commercially available particle filter. The particle filter 22 is preferably sized to remove an amount of solids based on the capacity and properties of the water supply and requirements of the point of use. Alternatively, the particle filter 22 is formed of two or more such filters connected in parallel and/or series depending upon the amount of solids to be removed from the water. As stated above, typically, two or more filters would be required only in large commercial or industrial applications.

An outlet of the particle filter 22 is connected to an inlet of an ultraviolet light source 24 for sanitizing the water prior to its point of use. The ultraviolet light source 24 preferably includes a housing (not shown) with at least one ultraviolet light bulb (not shown) disposed therein for exposing the water to the ultraviolet light rays to kill bacteria.

The ultraviolet light source 24 advantageously does not impact the taste or the odor of the water. The ultraviolet light source 24 also sanitizes the water instantaneously with no residual effects. The ultraviolet light source 24 is preferably a commercially available ultraviolet light source. Alternatively, the ultraviolet light source 24 is formed of two or more such light sources connected in parallel and/or series depending upon the amount of bacteria present. As stated above, typically, two or more sources would be required only in large commercial or industrial applications. An outlet of the ultraviolet light source 24 connects to a tee coupling 26, a branch of which is a point of use conduit 28, which is further connected to a point of use (not shown), such as a domestic water faucet, a water inlet for a dwelling, or a water inlet for industrial processing operations. The point of use conduit 28 and the tee 26 may be constructed of any suitable conduit material including, but not limited to, steel, copper, or PVC.

The bypass conduit 18 extends from the first tee 14 to the second tee 26. The water purification apparatus 10 also includes at least three valves, including a bypass valve 30, an inlet valve 32, and an outlet valve 34. The bypass valve 30 is located in the bypass conduit 18 between the tee 14 and the tee 26. The inlet valve 32 is located in the apparatus inlet conduit 16 between the tee 14 and the carbon filter 20. The outlet valve 34 is located in the apparatus inlet conduit 16 between the ultraviolet light source 24 and the tee 26.

During normal operation of the water purification apparatus 10, the bypass valve 30 is closed and the inlet valve 32 and the outlet valve 34 are open. Water flows from the municipal source into the water inlet conduit 12, through the carbon filter 20, through the particle filter 22, through the ultraviolet light source 24, through the point of use conduit 28, and on to the point of use. The water arrives at the point of use free of chlorine, free of solids and free of bacteria.

The carbon filter 20, the particle filter 22 and ultraviolet light source 24 all include parts that will need to be replaced during normal use of the water purification apparatus 10.

The frequency of parts replacement in the carbon filter 20 and the particle filter 22 depends in large part on the quality of the municipal water supply and the operating time in use. During maintenance of the water purification apparatus 10, the bypass valve 30 is open, and the inlet valve 32 and the outlet valve 34 are closed. In this valve configuration, maintenance personnel are able to perform maintenance including replacing the activated charcoal carbon filter 20, cleaning or replacing the filter cartridge in the particle filter 22, replacing the ultraviolet light bulbs in the ultraviolet light source 24, and/or performing any other maintenance on the water purification apparatus 10, between the inlet valve 32 and the outlet valve 34, as may be required. All of the maintenance may be performed without completely interrupting the water supply to the point of use and without requiring the drainage of the entire water system. The bypass conduit 18 allows for sanitizing the point of use water distribution network via the existing free chlorine in the water. The bypass conduit 18 may be utilized advantageously during off-peak hours or during times when taste, odor, or other chlorine characteristics are not an issue of significance. Utilizing the bypass conduit 18 during these times can increase the interval required to perform maintenance on the carbon filter 20, the particle filter 22 and ultraviolet light source 24, decreasing the likelihood that the bypass conduit 18 will need to be used during peak hours.

To assist in the maintenance of the water purification apparatus 10, the water supply inlet conduit 12 is connected to an optional water meter 36 that measures the amount of water flowing through the water purification apparatus 10. Information obtained from the water meter 36 can be used to size the system components and adjust them if necessary. The water meter 36 could be the meter typically used by the municipality to measure customer water use.

Preventative maintenance of mechanical systems is typically performed based on an amount of time the system has been in service or an amount of work cycles the system has experienced. Preventative maintenance is also typically based on observed conditions. Preventative maintenance of the water purification apparatus 10 may be performed based on the amount of water that has flowed through the water purification apparatus 10, as measured by the water meter 36. Preventative maintenance may also be performed on the water purification apparatus 10 based on actual pressure differential readings, as measured by at least three optional pressure gages 38, 40, and 42. The pressure gage 38 is located on the bypass conduit 18 between the tee 14 and the tee 26. The pressure gage 40 is located in the apparatus inlet conduit 16 between the tee 14 and the carbon bed filter 20. The pressure gage 42 is located in the apparatus inlet conduit 16 between the ultraviolet light source 24 and the tee 26. A high pressure differential between the pressure gage 40 and the pressure gage 42 will indicate that there likely is a flow restriction in either the carbon filter 20, the particle filter 22 and/or the ultraviolet light source 24, and that maintenance, such as that outlined above, is required on one of those purification devices.

Also, the water meter 36 and the pressure gages 38, 40, and 42 provide signals (not shown) to a control means (not shown), which can monitor the water purification apparatus 10, and alert an operator of the water purification apparatus 10 when maintenance needs to be performed.

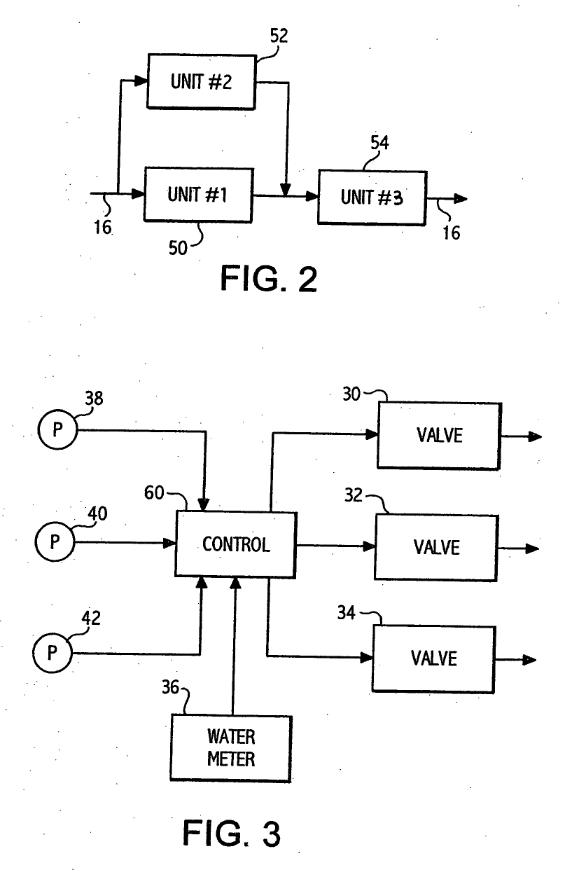

As discussed above, each of the purification units, i.e. the carbon filter 20, the particle filter 22 and the UV light source 24, can be configured as two or more units in parallel and/or series. As shown in FIG. 2, a first unit 50 can be connected in parallel with a similar second unit 52. The parallel connection can be used where one of the units does not have sufficient capacity for the maximum water flow in the inlet conduit 16. Also, the second unit 52 can be added after installation of the water purification apparatus 10 should the maximum water flow increase and exceed the capacity of the first unit 50. A third unit 54 can be connected in series with the first unit 50 when additional purification is required beyond the capacity of the first unit 50 but the maximum flow capacity has not been exceeded. In this case, the second unit 52 may not be required. Additional parallel or series connected units can be added. Clearly, the water purification apparatus 10 can be configured with any desired number of purification units (20, 22, 24) connected in series and/or parallel.

There is shown in FIG. 3 a control 60 for the water purification apparatus 10. The pressure gages 38, 40 and 42 are each connected to an input of the control 60 and generate input signals representing the water pressure at the points of connection to the conduits shown in the FIG. 1. The water meter 36 is connected to another input of the control 60. Outputs of the control 60 are connected to actuators of the valves 30, 32 and 34. The control 60 can be any suitable device such as a programmed logic controller (PLC) or a programmed personal computer that responds to inputs such as the sensed pressures (from the gages 38, 40, 42), the water flow rate (from the water meter 36), the time of day (from an internal clock) or operator commands to open and shut the valves.

The U.S. Provisional patent application Serial No. 60/492,460, filed Aug. 4, 2003, and the U.S. Provisional patent application Serial No. 60/568,305, filed May 5, 2004, are incorporated herein by reference.

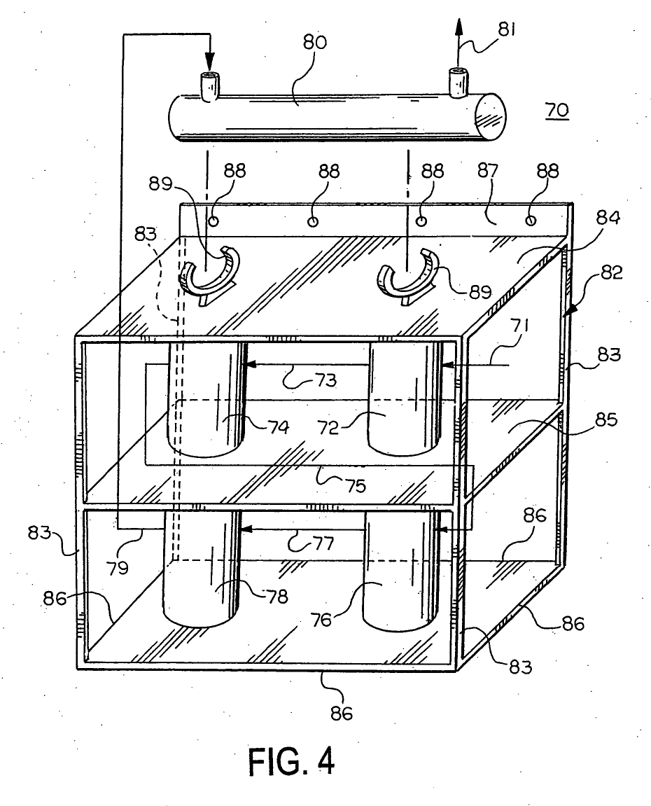

There is shown in FIG. 4 a compact water purification apparatus 70 in accordance with the present invention. The compact water purification apparatus 70 includes a water purification circuit having a water supply inlet conduit 71 that is connected to a water supply (not shown) for receiving water to be used at a point of use for drinking, cooking, bathing, etc. The water supply inlet conduit 71 is connected to an inlet of a first water filter 72 having an outlet connected to a first connection conduit 73. The conduit 73 is connected to an inlet of a second water filter 74 having an outlet connected to a second connection conduit 75. The conduit 75 is connected to an inlet of a third water filter 76 having an outlet connected to a third connection conduit 77. The conduit 77 is connected to an inlet of a fourth water filter 78 having an outlet connected to a fourth connection conduit 79. The conduit 79 is connected to an inlet of a sterilization unit 80 having an outlet connected to a water outlet conduit 81.

The water filters 72, 74, 76 and 78 can be of the replaceable cartridge type such as a Model BF7 filter, a Model U25 Series A filter, a Model OB5 filter or a Model OB1 filter available from OmniFilter Corp. of Hammond, Ind. There are many different types of cartridges that are available for removing various substances from the water flowing through the compact water purification apparatus 70. For example, there are cartridges for removing: chlorine; rust and sediment; chlorine and heavy metal; dissolved iron and hydrogen sulfide; chlorine and chloroform; lead; and sediment. The sterilization unit 80 can be an ultraviolet water sterilizer of the type available from WaterTec of Pan-Chiao City, Taipei, Taiwan, such as a Model UV6A.

The water filters 72, 74, 76 and 78 and the sterilization unit 80 are mounted on a frame 82 in a compact configuration. The frame 82 includes four vertically extending posts 83 that define the comers of a rectangular shaped package. A generally horizontally extending top wall 84 is attached to the top ends of the posts 83. A lower surface of the top wall 84 functions as a mounting surface for the filters 72 and 74. A generally horizontally extending middle wall 85 is attached to the posts 83 in a central area thereof. A lower surface of the middle wall 85 functions as a mounting surface for the filters 76 and 78. The bottom ends of the posts 83 are connected by stringers 86 to stabilize the frame 82. Of course, a bottom wall (not shown) could be used in place of the stringers 86. The length of the posts 83 is selected to provide enough room to remove the housing of each of the water filters 72, 74, 76 and 78 for cartridge replacement, which housing unscrews from the top cover or cap that is attached to the wall 84 or 85. A typical length for the posts 83 is 36″, but they can be 30″ if the middle wall 85 and the water filters 76 and 78 are not required.

If the water filters 76 and 78 and the connector conduits 77 and 79 are not used, the second connector conduit is connected to the inlet of the sterilization unit 80. In an alternate circuit configuration, the inlet conduit 71 can also be connected to the inlet of the water filter 76 and the second connector conduit 75 can be connected between the outlet of the water filter 74 and the inlet of the sterilization unit 80. This alternate configuration provides two parallel filtering paths between the inlet conduit 71 and the sterilization unit 80. Furthermore, the cartridge can be left out of the housing of one or more of the water filters 72, 74, 76 and 78 and the apparatus 70 will continue to operate.

The frame 82 can rest on a horizontal surface, such as a floor or a countertop, or can be mounted on a vertical surface, such as a wall. A mounting plate 87 extends vertically upwardly from a back edge of the top wall 84 and has a plurality of mounting holes 88 formed therein for receiving fasteners (not shown). Two spaced apart C-shaped brackets 89 are attached to the upper surface of the top wall 84 for releasably retaining the sterilization unit 80. The brackets 89 can be formed of a resilient plastic material for a snap fit with the housing of the unit 80.

Referring to FIGS. 1 and 3, the compact water purification apparatus 70 can be substituted for the carbon filter bed 20, the particle filter 22 and the UV light source 24 by connecting the inlet conduit 71 to the inlet conduit 16 at the pressure gage 40 and connecting the outlet conduit 81 to the inlet conduit 16 at the pressure gage 42. Furthermore, the valves 30, 32 and 34 typically are manually actuated, but also could be electrically actuated as shown in FIG. 3 where, for example, the compact water purification apparatus 70 can be located in a basement of a house and a control switch or button for the control 60 can be located in a kitchen of the house.

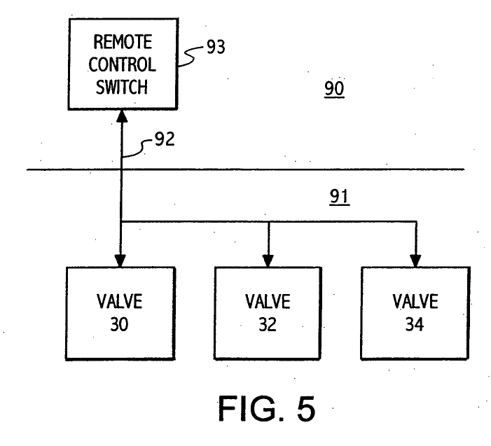

There is shown in FIG. 5 a remote control circuit for the valves 30, 32 and 34. A remote control switch 93 is located in a first space 90 such as a kitchen of a house. The valves 30, 32 and 34 are located in a second space 91 such as a basement of the house. The remote control switch 93 controls the valves 30, 32 and 34 through a signal communication means 92 using any suitable method of signal communication such as dedicated hard wiring, radio frequency, or local area network as examples. The remote control switch 93 can be used by a person to selectively actuate the valves 30, 32 and 34, or, the remote control switch 93 can include a timer that automatically switches the valves at one or more regular predetermined times. An automatic sprinkler system control including valves that are remotely actuated by a timer, such as is available from The Toro Company of Bloomington, Minn., could be used for the remote control switch 93 and the valves 30, 32 and 34 shown in FIG. 5.

A reverse osmosis water treatment system, such as the PureWaterMachine™ system available from Vertex Research of Sydney, Australia, can be incorporated in the system according to the present invention. The reverse osmosis membrane can be used to remove dissolved solids and typically would be installed downstream from the particle filter 22 shown in FIG. 1, before or after the UV light source 24. Note also that the order of the sediment filter and the carbon filter is switched which can be the case with the system according to the present invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A water purification apparatus for purifying water from a supply of water having a quantity of free residual chlorine comprising:
a frame;
a first cartridge type water filter attached to frame and having an inlet adapted to be connected to a water supply;
a second cartridge type water filter attached to said frame and having an inlet connected to an outlet of said first cartridge type water filter; and
a sterilization unit removably attached to said frame and having an inlet connected to an outlet of said second cartridge type water filter and having an outlet adapted to be connected to a water point of use.

2. The apparatus according to claim 1 wherein said first and second cartridge type water filters each contain a cartridge for removing one or more of the substances: chlorine; rust and sediment; chlorine and heavy metal; dissolved iron and hydrogen sulfide; chlorine and chloroform; lead; and sediment.

3. The apparatus according to claim 1 wherein said sterilization unit is an ultraviolet light source.

4. The apparatus according to claim 1 further including a third cartridge type water filter attached to said frame and having an inlet connected to an outlet of said second cartridge type water filter, a fourth cartridge type water filter attached to said frame and having an inlet connected to an outlet of said third cartridge type water filter, and wherein said sterilization unit inlet is connected to an outlet of said fourth cartridge type water filter.

5. The apparatus according to claim 5 wherein said frame includes a plurality of vertically extending posts attached to a top wall and middle wall, said first and second cartridge water filters being attached to a bottom surface of said top wall, said third and fourth cartridge water filters being attached to a bottom surface of said middle wall, and said sterilization unit being removably attached to a top surface of said top wall.

6. The apparatus according to claim 5 wherein said first through fourth cartridge type water filters each contain a cartridge for removing one or more of the substances: chlorine; rust and sediment; chlorine and heavy metal; dissolved iron and hydrogen sulfide; chlorine and chloroform; lead; and sediment.

7. The apparatus according to claim 5 wherein said sterilization unit is an ultraviolet light source.

8. The apparatus according to claim 1 including a bypass conduit connected in parallel with said first and second filters by at least two valves operable to alternately direct a flow of water from the water supply to the water point of use through said first and second filters and the bypass conduit.

9. The apparatus according to claim 8 including a remote control for operating said at least two valves.

10. The apparatus according to claim 9 wherein said remote control includes a timer for automatically operating said at least two valves at one or more predetermined times.

11. The apparatus according to claim 1 including a reverse osmosis filter connected downstream of said second filter.
